(19) United States
(12) Patent Application Publication
(10) Pub. No.: US 2017/0200571 A1
(43) Pub. Date: Jul. 13, 2017

(54) KEY STRUCTURE

(71) Applicant: Primax Electronics Ltd., Taipei (TW)

(72) Inventor: YI-CHEN WANG, Taipei (TW)

(21) Appl. No.: 15/064,439

(22) Filed: Mar. 8, 2016

(30) Foreign Application Priority Data
Jan. 8, 2016 (TW) 105100610

(51) Int. Cl. H01H 3/12

(52) U.S. Cl. CPC H01H 3/125

(57) ABSTRACT

A key structure includes a keycap, a scissors-type connecting element, a metal triggering element, a switch circuit board, a base and a buffering element. The buffering element is integrally formed with the keycap, and fixed on an inner surface of the keycap. The buffering element is made of a soft material. As the keycap is depressed and moved, the buffering element is pushed by the keycap and subject to deformation. Consequently, the movable distance of the keycap is increased. That is, the tactile feel of depressing the keycap is enhanced.

### FIELD OF THE INVENTION

The present invention relates to a key structure, and more particularly to a key structure with a scissors-type connecting element.

### BACKGROUND OF THE INVENTION

Generally, the widely-used peripheral input device of a computer system includes for example a mouse, a keyboard, a trackball, or the like. Via the keyboard, characters or symbols can be directly inputted into the computer system. As a consequence, most users and most manufacturers of input devices pay attention to the development of keyboards. As known, a keyboard with scissors-type connecting elements is one of the widely-used keyboards.

Hereinafter, a key structure with a scissors-type connecting element of a conventional keyboard will be illustrated with reference to FIG. 1. FIG. 1 is a schematic side cross-sectional view illustrating a conventional key structure. As shown in FIG. 1, the conventional key structure 1 comprises a keycap 11, a scissors-type connecting element 12, a rubbery elastomer 13, a membrane switch circuit member 14 and a base 15. The keycap 11, the scissors-type connecting element 12, the rubbery elastomer 13 and the membrane switch circuit member 14 are supported by the base 15. The scissors-type connecting element 12 is used for connecting the base 15 and the keycap 11.

The scissors-type connecting element 12 is arranged between the base 15 and the keycap 11, and the base 15 and the keycap 11 are connected with each other through the scissors-type connecting element 12. The scissors-type connecting element 12 comprises a first frame 121 and a second frame 122. A first end of the first frame 121 is connected with the keycap 11. A second end of the first frame 121 is connected with the base 15. The rubbery elastomer 13 is enclosed by the scissors-type connecting element 12. The membrane switch circuit member 14 comprises plural key intersections (not shown). When one of the plural key intersections is triggered, a corresponding key signal is generated. The rubbery elastomer 13 is disposed on the membrane switch circuit member 14. Each rubbery elastomer 13 is aligned with a corresponding key intersection. When the rubbery elastomer 13 is depressed, the rubbery elastomer 13 is subjected to deformation to push the corresponding key intersection of the membrane switch circuit member 14. Consequently, the corresponding key signal is generated.

The operations of the conventional key structure 1 in response to the depressing action of the user will be illustrated as follows. Please refer to FIG. 1 again. When the keycap 11 is depressed, the keycap 11 is moved downwardly to push the scissors-type connecting element 12 in response to the depressing force. As the keycap 11 is moved downwardly relative to the base 15, the keycap 11 pushes the corresponding rubbery elastomer 13. At the same time, the rubbery elastomer 13 is subjected to deformation to push the membrane switch circuit member 14 and trigger the corresponding key intersection of the membrane switch circuit member 14. Consequently, the membrane switch circuit member 14 generates a corresponding key signal. When the keycap 11 is no longer depressed by the user, no external force is applied to the keycap 11 and the rubbery elastomer 13 is no longer pushed by the keycap 11. In response to the elasticity of the rubbery elastomer 13, the rubbery elastomer 13 is restored to its original shape to provide an upward elastic restoring force. Consequently, the keycap 11 is returned to its original position where it is not depressed. The structures and the operations of the conventional key structure have been mentioned as above.

With increasing development of science and technology, the demand on a slim-type keyboard is gradually increased. For example, a slim-type keyboard as shown in FIG. 2 is introduced into the market. FIG. 2 is a schematic side cross-sectional view illustrating another conventional key structure. As shown in FIG. 2, the conventional key structure 2 comprises a keycap 21, a scissors-type connecting element 22, a metal triggering element 23, a membrane switch circuit member 24 and a base 25. The structures and functions of the keycap 21, the scissors-type connecting element 22, the membrane switch circuit member 24 and the base 25 are substantially identical to those of the corresponding components of the key structure 1, and are not redundantly described herein. In comparison with the key structure 1, the key structure 2 comprises the metal triggering element 23 in replace of the rubbery elastomer 13.

The metal triggering element 23 is disposed on the membrane switch circuit member 24. When the metal triggering element 23 is pushed by the keycap 21, the metal triggering element 23 is subjected to deformation to push the membrane switch circuit member 24. Consequently, a corresponding key signal is generated. When the keycap 21 is no longer depressed by the user, the deformed metal triggering element 23 is restored to its original shape to provide an upward pushing force. Consequently, the keycap 21 is returned to its original position where it is not depressed. The metal triggering element 23 is made of a metallic material. Moreover, the thickness of the metal triggering element is smaller than the thickness of the rubbery elastomer 13. Consequently, the overall thickness of the conventional key structure 2 is smaller than the overall thickness of the conventional key structure 1. Moreover, a pressing part 211 is disposed on an inner surface of the keycap 21 and aligned with the metal triggering element 23. The pressing part 211 is integrally formed with the keycap 21. Moreover, both of the pressing part 211 and the keycap 21 are made of a plastic material.

However, since the metal triggering element 23 is made of a metallic material, some problems may occur. For example, when the keycap 21 is depressed by the used, the metal triggering element 23 made of the metallic material may adversely affect the tactile feel of depressing the keycap 21.

Therefore, there is a need of providing a key structure with slimness and enhanced tactile feel.

### SUMMARY OF THE INVENTION

The present invention provides a key structure with slimness and enhanced tactile feel.

In accordance with an aspect of the present invention, there is provided a key structure. The key structure includes a switch circuit board, a metal triggering element, a keycap and a buffering element. The metal triggering element is disposed over the switch circuit board. The switch circuit board is triggered by the metal triggering element in response to an external force. The keycap is disposed over the metal triggering element. When the external force is applied to the keycap, the keycap is moved. The buffering element is disposed on an inner surface of the keycap, and contacted with the metal triggering element. As the keycap is moved, the metal triggering element is pushed by the buffering element. The buffering element is fixed on the inner surface of the keycap through a coupling means.

In accordance with another aspect of the present invention, there is provided a key structure. The key structure includes a switch circuit board, a metal triggering element, a keycap and a buffering element. The metal triggering element is disposed over the switch circuit board. The switch circuit board is triggered by the metal triggering element in response to an external force. The keycap is disposed over the metal triggering element. When the external force is applied to the keycap, the keycap is moved. The buffering element is disposed on the metal triggering element. As the keycap is moved, the metal triggering element is pushed by the buffering element. The buffering element is fixed on the metal triggering element through a coupling means.

From the above descriptions, the present invention provides a key structure. The key structure has a metal triggering element in replace of the rubbery elastomer of the conventional key structure. Consequently, the thickness of keyboard with the key structure of the present invention is smaller. That is, the keyboard is slimmer. Moreover, a buffering element made of a soft material is arranged between a keycap and the metal triggering element, or the buffering element is integrally formed with the metal triggering element. Consequently, when the keycap is depressed by the user, the buffering element is pushed by the key and subject to deformation. Under this circumstance, a space for continuously moving the keycap is provided, and the movable distance of the keycap toward the switch circuit board is increased. Consequently, the tactile feel of depressing the keycap is enhanced.

The above objects and advantages of the present invention will become more readily apparent to those ordinarily skilled in the art after reviewing the following detailed description and accompanying drawings, in which:

### BRIEF DESCRIPTION OF THE DRAWINGS

FIG. 1 is a schematic side cross-sectional view illustrating a conventional key structure;

FIG. 2 is a schematic side cross-sectional view illustrating another conventional key structure;

FIG. 3 is a schematic exploded view illustrating a key structure according to a first embodiment of the present invention;

FIG. 4 is a schematic side cross-sectional view illustrating the key structure according to the first embodiment of the present invention, in which the keycap is not depressed;

FIG. 5 is a schematic side cross-sectional view illustrating the key structure according to the first embodiment of the present invention, in which the keycap is depressed;

FIG. 6 is a schematic exploded view illustrating a key structure according to a second embodiment of the present invention;

FIG. 7 is a schematic side cross-sectional view illustrating the key structure according to the second embodiment of the present invention, in which the keycap is not depressed; and

FIG. 8 is a schematic side cross-sectional view illustrating the key structure according to the second embodiment of the present invention, in which the keycap is depressed.

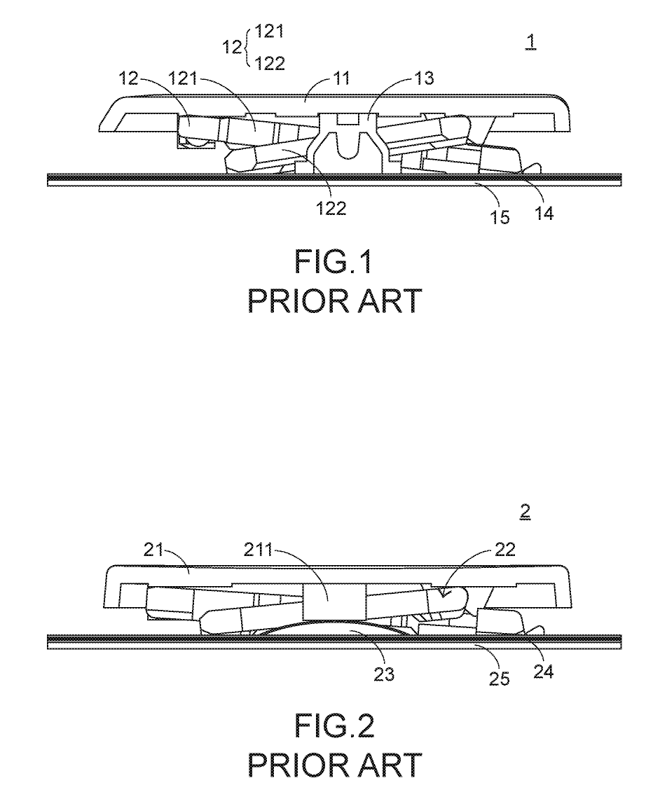

### DETAILED DESCRIPTION OF THE PREFERRED EMBODIMENT

For solving the drawbacks of the conventional technologies, the present invention provides a key structure with enhanced structural strength and slim appearance.

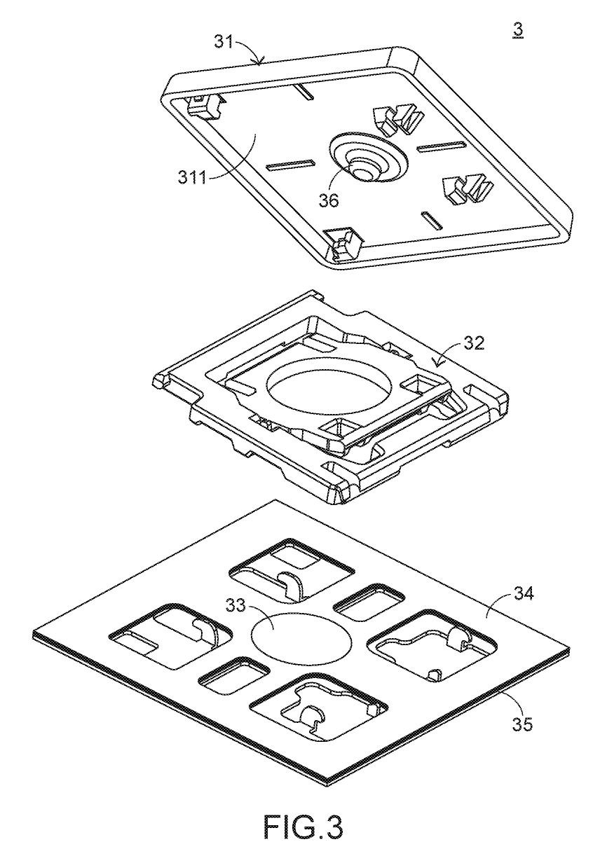

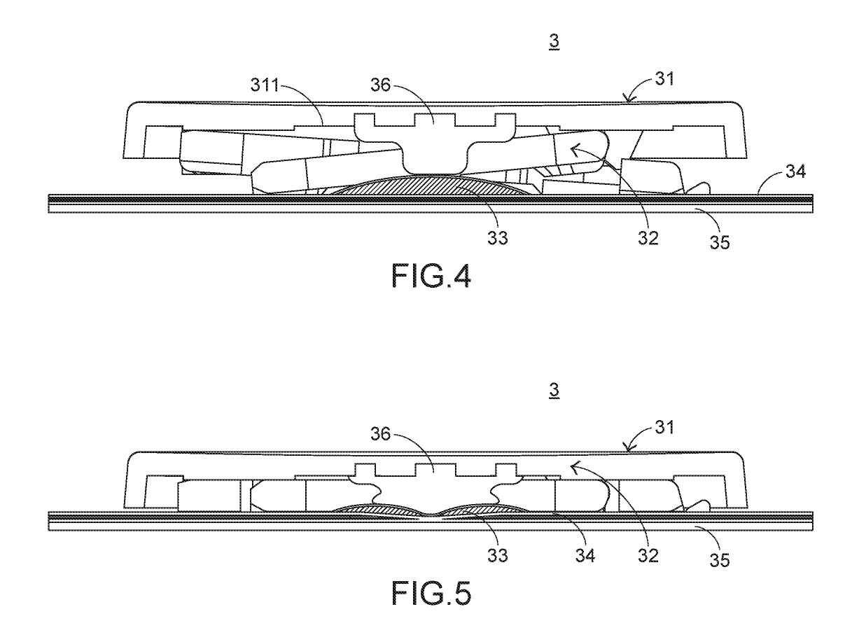

FIG. 3 is a schematic exploded view illustrating a key structure according to a first embodiment of the present invention. FIG. 4 is a schematic side cross-sectional view illustrating the key structure according to the first embodiment of the present invention. As shown in FIGS. 3 and 4, the key structure 3 comprises a keycap 31, a scissors-type connecting element 32, a metal triggering element 33, a switch circuit board 34, a base 35 and a buffering element 36. The base 35 is connected with the scissors-type connecting element 32. The keycap 31, the scissors-type connecting element 32, the metal triggering element 33 and the switch circuit board 34 are supported by the base 35. The switch circuit board 34 is disposed over the base 35. Moreover, the switch circuit board 34 is disposed under the metal triggering element 33 and contacted with the metal triggering element 33. The switch circuit board 34 has a key intersection (not shown) corresponding to the metal triggering element 33. The metal triggering element 33 over the switch circuit board 34 is inserted into an inner space of the scissors-type connecting element 32. In response to an external force on the metal triggering element 33, the switch circuit board 34 is triggered by the metal triggering element 33. In this embodiment, the switch circuit board 34 is an elastic sheet made of a metallic material, and the switch circuit board 34 is a membrane switch circuit member.

The keycap 31 is connected with the scissors-type connecting element 32, and disposed over the metal triggering element 33. In response to an external force applied to the keycap 31, the keycap 31 is moved upwardly or downwardly relative to the base 35. As the scissors-type connecting element 32 is swung, the keycap 31 is moved upwardly or downwardly relative to the base 35. The buffering element 36 is disposed on an inner surface 311 of the keycap 31. The buffering element 36 is contacted with the metal triggering element 33. Moreover, the buffering element 36 is moved upwardly or downwardly with the keycap 31. Consequently, the underlying metal triggering element 33 can be triggered by the buffering element 36. The buffering element 36 is fixed on the inner surface 311 of the keycap 31 through a coupling means. In this embodiment, the keycap 31 is made of a plastic material, and the buffering element 36 is made of a soft material. Preferably but not exclusively, the coupling means is an injection molding process for forming the keycap 31 and the buffering element 36, and thus the buffering element 36 is integrally formed with the keycap 31. In another embodiment, the coupling means is a means for attaching the buffering element on the inner surface of the keycap.

As shown in FIG. 4, the components of the key structure 3 from top to bottom include the keycap 31, the buffering element 36, the scissors-type connecting element 32, the metal triggering element 33, the switch circuit board 34 and the base 35 sequentially. The metal triggering element 33 is arranged between the keycap 31 and the switch circuit board 34. Moreover, the metal triggering element 33 is enclosed by the scissors-type connecting element 32. The buffering element 36 is disposed over the metal triggering element 33, and contacted with the metal triggering element 33.

After the above components are combined with each other, the key structure 3 as shown in FIG. 4 is assembled. The operations of the conventional key structure 3 in response to the depressing action of the user will be illustrated as follows. FIG. 5 schematically illustrates the key structure 3 when the keycap 31 is depressed. When the keycap 31 is depressed, the keycap 31 is moved downwardly to push the scissors-type connecting element 32 in response to the depressing force. Consequently, the scissors-type connecting element 32 is activated. As the keycap 31 is moved downwardly relative to the base 35, the buffering element 36 is moved downwardly to push the metal triggering element 33. At the same time, the metal triggering element 33 is subjected to deformation to push the switch circuit board 34 and trigger the corresponding key intersection of the switch circuit board 34. Consequently, the switch circuit board 34 generates a corresponding key signal.

When the keycap 31 is no longer depressed by the user, no external force is applied to the keycap 31 and the metal triggering element 33 is no longer pushed by the buffering element 36. In response to the elasticity of the metal triggering element 33, the metal triggering element 33 is restored to its original shape to provide an upward elastic restoring force. In response to the upward elastic restoring force, the keycap 31 is returned to its original position where it is not depressed.

Moreover, while the buffering element 36 is moved downwardly to push the metal triggering element 33, the buffering element 36 is compressed between the keycap 31 and the metal triggering element 33 and subjected to deformation because the buffering element 36 is made of the soft material. Consequently, the keycap 31 is moved downwardly for a certain distance continuously. That is, the movable distance of the keycap 31 toward the switch circuit board 34 is increased. In other words, since the buffering element 36 of the key structure 3 is made of the soft material, the stiff feel caused by the metal triggering element 33 is alleviated. Moreover, since the movable distance of the keycap 31 toward the switch circuit board 34 is increased, the tactile feel of depressing the keycap 31 is enhanced.

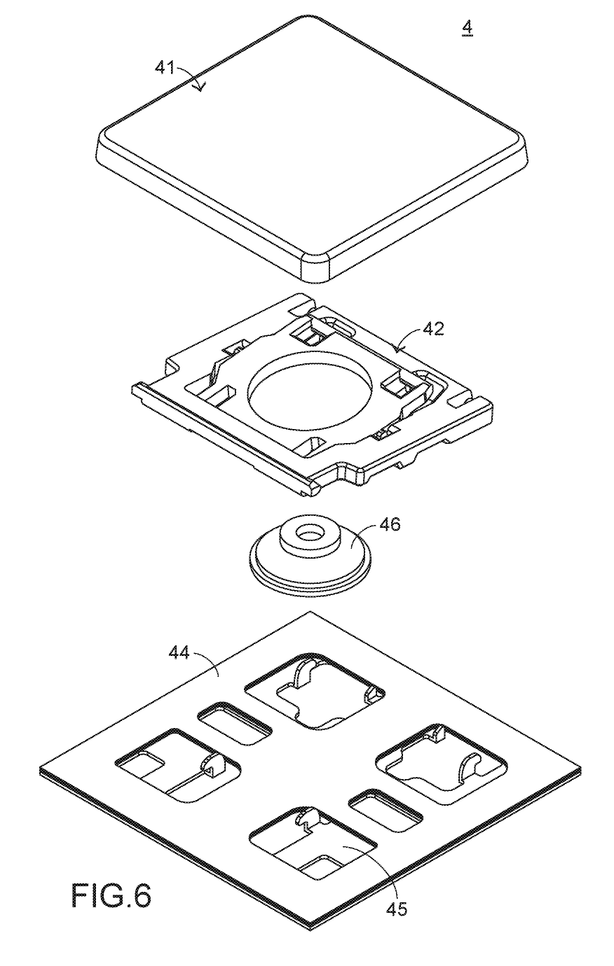

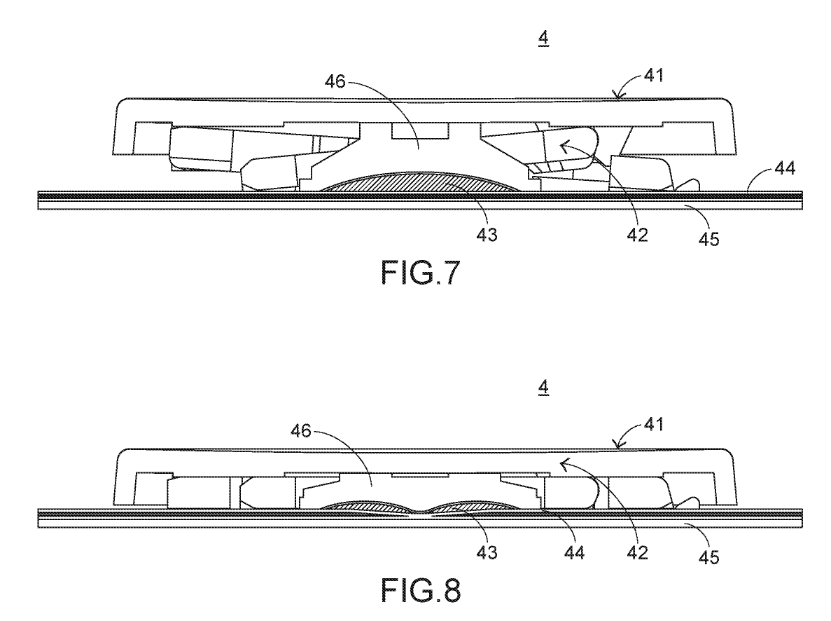

The present invention further provides a second embodiment, which is distinguished from the first embodiment. FIG. 6 is a schematic exploded view illustrating a key structure according to a second embodiment of the present invention. FIG. 7 is a schematic side cross-sectional view illustrating the key structure according to the second embodiment of the present invention. As shown in FIGS. 6 and 7, the key structure 4 comprises a keycap 41, a scissors-type connecting element 42, a metal triggering element 43, a switch circuit board 44, a base 45 and a buffering element 46. The structures and functions of the components of the key structure 4 which are identical to those of the first embodiment are not redundantly described herein. In comparison with the first embodiment, the buffering element 46 of the key structure 4 of this embodiment is distinguished.

The buffering element 46 is arranged between the keycap 41 and the metal triggering element 43, disposed over the metal triggering element 43. When the buffering element 46 is pushed by the keycap 41, the buffering element 46 is subjected to deformation. The buffering element 46 is fixed on the metal triggering element 43 through a coupling means. In this embodiment, the buffering element 46 is made of a soft material, and the metal triggering element 43 is made of a metallic material. Preferably but not exclusively, the coupling means is an insert molding process for forming the metal triggering element 43 and the buffering element 46, and thus the buffering element 46 is integrally formed with the metal triggering element 43.

After the above components are combined with each other, the key structure 4 as shown in FIG. 7 is assembled. The operations of the conventional key structure 4 in response to the depressing action of the user will be illustrated as follows. FIG. 8 schematically illustrates the key structure 4 when the keycap 41 is depressed. When the keycap 41 is depressed, the keycap 41 is moved downwardly to push the scissors-type connecting element 42 in response to the depressing force. Consequently, the scissors-type connecting element 42 is activated. As the keycap 41 is moved downwardly relative to the base 45 to push the buffering element 46, the buffering element 46 is subjected to deformation. At the same time, since the metal triggering element 43 is integrally formed with the buffering element 46, the metal triggering element 43 is pushed by the buffering element 46 and subjected to deformation. The corresponding key intersection (not shown) of the switch circuit board 44 is triggered by the metal triggering element 43. Consequently, the switch circuit board 44 generates a corresponding key signal.

When the keycap 41 is no longer depressed by the user, no external force is applied to the keycap 41 and the buffering element 46 is no longer pushed by the keycap 41. In response to the elasticity of the metal triggering element 43, the metal triggering element 43 is restored to its original shape to provide an upward elastic restoring force. In response to the upward elastic restoring force, the keycap 41 is returned to its original position where it is not depressed.

Moreover, while the buffering element 46 is moved downwardly, the buffering element 46 made of the soft material is pushed by the keycap 41 and subjected to deformation. Consequently, the keycap 41 is moved downwardly for a certain distance continuously. That is, the movable distance of the keycap 41 toward the switch circuit board 44 is increased. Consequently, the tactile feel of depressing the keycap 41 is enhanced.

From the above descriptions, the present invention provides a key structure. The key structure has a metal triggering element in replace of the rubbery elastomer of the conventional key structure. Consequently, the thickness of keyboard with the key structure of the present invention is smaller. That is, the keyboard is slimmer. Moreover, a buffering element made of a soft material is arranged between a keycap and the metal triggering element, or the buffering element is integrally formed with the metal triggering element. Consequently, when the keycap is depressed by the user, the buffering element is pushed by the key and subject to deformation. Under this circumstance, a space for continuously moving the keycap is provided, and the movable distance of the keycap toward the switch circuit board is increased. Consequently, the tactile feel of depressing the keycap is enhanced.

While the invention has been described in terms of what is presently considered to be the most practical and preferred embodiments, it is to be understood that the invention needs not be limited to the disclosed embodiments. On the contrary, it is intended to cover various modifications and similar arrangements included within the spirit and scope of the appended claims which are to be accorded with the broadest interpretation so as to encompass all modifications and similar structures.

What is claimed is:

1. A key structure, comprising:
a switch circuit board;
a metal triggering element disposed over the switch circuit board, wherein the switch circuit board is triggered by the metal triggering element in response to an external force;
a keycap disposed over the metal triggering element, wherein when the external force is applied to the keycap, the keycap is moved; and
a buffering element disposed on an inner surface of the keycap, and contacted with the metal triggering element, wherein as the keycap is moved, the metal triggering element is pushed by the buffering element, wherein the buffering element is fixed on the inner surface of the keycap through a coupling means.

2. The key structure according to claim 1, wherein the coupling means is an injection molding process for forming the keycap and the buffering element, so that the buffering element is integrally formed with the keycap.

3. The key structure according to claim 1, wherein the buffering element is attached on the inner surface of the keycap through the coupling means.

4. The key structure according to claim 1, further comprising:
a base, wherein the switch circuit board and the metal triggering element are supported by the base; and
a scissors-type connecting element connected with the keycap and the base, wherein the metal triggering element and the buffering element are inserted into an inner space of the scissors-type connecting element, wherein as the scissors-type connecting element is swung, the keycap is moved relative to the base.

5. The key structure according to claim 1, wherein when the keycap is moved relative to the base and toward the switch circuit board, the buffering element is compressed between the keycap and the metal triggering element and subjected to deformation, so that a movable distance of the keycap toward the switch circuit board is increased.

6. A key structure, comprising:
a switch circuit board;
a metal triggering element disposed over the switch circuit board, wherein the switch circuit board is triggered by the metal triggering element in response to an external force;
a keycap disposed over the metal triggering element, wherein when the external force is applied to the keycap, the keycap is moved; and
a buffering element disposed on the metal triggering element, wherein as the keycap is moved, the metal triggering element is pushed by the buffering element, wherein the buffering element is fixed on the metal triggering element through a coupling means.

7. The key structure according to claim 6, wherein the coupling means is an insert molding process for forming the metal triggering element and the buffering element, so that the buffering element is integrally formed with the metal triggering element.

8. The key structure according to claim 6, wherein the buffering element is made of a soft material, and the metal triggering element is made of a metallic material.

9. The key structure according to claim 6, further comprising:
a base, wherein the switch circuit board and the metal triggering element are supported by the base; and
a scissors-type connecting element connected with the keycap and the base, wherein the metal triggering element and the buffering element are inserted into an inner space of the scissors-type connecting element, wherein as the scissors-type connecting element is swung, the keycap is moved relative to the base.

10. The key structure according to claim 6, wherein when the keycap is moved relative to the base and toward the switch circuit board, the buffering element is pushed by the keycap and subjected to deformation, so that a movable distance of the keycap toward the switch circuit board is increased.
